(19) United States
(12) Patent Application Publication
(10) Pub. No.: US 2018/0360270 A1
(43) Pub. Date: Dec. 20, 2018

(54) FOOD PREPARATION DEVICE

(71) Applicant: ADIAMAS, Palladuc (FR)

(72) Inventors: Erwan HERAULT, Bourg-en-Bresse (FR); Fabien RONZE, Bulhon (FR); Patrick JANVIER, Lezoux (FR); Julien MONDIERE, Escoutoux (FR)

(73) Assignee: ADIAMAS, Palladuc (FR)

(21) Appl. No.: 16/060,465

(22) PCT Filed: Dec. 8, 2016
(86) PCT No.: PCT/FR2016/053283

§ 371 Date: Jun. 8, 2018

(30) Foreign Application Priority Data
Dec. 10, 2015 (FR) 1562124

(51) Int. Cl. A47J 43/046; A47J 43/07; A47J 43/08

(52) U.S. Cl. CPC A47J 43/046; A47J 43/085; A47J 43/0722

(57) ABSTRACT

Disclosed is a food preparation device including: a container suitable for receiving food for preparation, the container presenting a bottom and a side wall that rises from the bottom generally along a vertical axis; and at least two blades arranged in the container, each blade being driven in rotation about an axis of rotation, the axis of rotation of at least one of the blades extending in the direction of the vertical axis. The axis of rotation of at least one of the other blades is inclined at a non-zero angle of inclination relative to the vertical axis.

### TECHNICAL FIELD TO WHICH THE INVENTION RELATES

The present invention relates in general manner to the field of food preparation devices.

More particularly, it relates to a food preparation device comprising:
a container suitable for receiving food for preparation, the container presenting a bottom and a side wall that rises from the bottom generally along a vertical axis; and
at least two blades arranged in the container, each blade being driven in rotation about an axis of rotation, the axis of rotation of at least one of the blades extending in the direction of said vertical axis.

In particular, the invention relates to small household electrical appliances, such as those commonly referred to as “blenders”, “mixers”, “meat grinders”, or indeed “mini-meat grinders”, used for processing or transforming food preparations, specifically for example in order to blend, mix, grind, or liquidize food, or indeed reduce it to a puree.

### TECHNOLOGICAL BACKGROUND

Numerous food preparation devices of the above-specified type are presently available on the market, which devices have a blade arranged therein close to the bottom of the container. The container is placed on a stand that encloses a motor for driving the blade in rotation about a vertical axis of rotation in order to process food.

Some such devices are for transforming food, e.g. mixing, grinding, or liquidizing food so as to obtain smoothies, milkshakes, soups, or indeed crushed ice.

Given those various transformations manufacturers have increased the number of blades provided in the containers, and they have adapted their respective shapes and their arrangements on the vertical axis of rotation.

Nevertheless, the operation of those food preparation devices leads to a large amount of waste, i.e. food that has not been processed.

Specifically, after a complete operating cycle that includes setting each of the blades into rotation, transforming the food over a given length of time at one or more selected speeds, and stopping the blades, there remains food that has not been processed in the bottom of such containers.

This results in non-uniform preparation of the food that has been processed.

In order to obtain a uniform preparation from such food preparation devices, it is consequently necessary to repeat operating cycles, which in practice is not very effective and consumes energy.

Also known from Document US 2005/0018534, is a food preparation device in which a plurality of blades are provided that are driven in rotation about distinct axes of rotation. Those axes of rotation are either all inclined relative to the vertical axis and directed towards the wall of the container, or else they are all oriented in the direction of the vertical axis.

That arrangement of the blades improves the processing of food but nevertheless without the stirring of the food being entirely satisfactory.

### OBJECT OF THE INVENTION

In order to remedy the above-mentioned drawbacks of the state of the art, the present invention proposes a food preparation device as described in the introduction in which provision is made for the axis of rotation of at least one of the other blades to be inclined at a non-zero angle of inclination relative to said vertical axis.

Thus, advantageously, the arrangement of the blades of the device of the invention makes it possible to break the generally circular movement of the stream of material around the vertical axis of the container, thereby facilitating the flow of food within said container; the food is thus processed more uniformly during an operating time that is shorter.

In other words, associating a blade having its axis of rotation that is vertical with a blade having its axis of rotation that is inclined makes it possible to improve the stirring of food within the container.

In addition, in the device of the invention, the food is likely to encounter each blade several times over, thereby advantageously reducing the quantity of waste generated during the operation of said food preparation device.

Other characteristics of the food preparation device in accordance with the invention that are non-limiting and advantageous are as follows:
the value of each angle of inclination lies in the range 5 degrees to 90 degrees;
the value of at least one angle of inclination lies in the range 40 degrees to 90 degrees;
at least one axis of rotation is provided that is common to at least two blades;
two blades carried by the common axis of rotation are separated from each other by a distance lying in the range 5 millimeters (mm) to 50 mm along said common axis of rotation;
at least one of the blades is positioned in the proximity of the bottom of the container;
at least two blades present opposite directions of rotation;
at least one of the blades presents a sharp cutting edge;
at least one of the blades is a stirring paddle;
the blades are mounted on blade driveshafts that are driven in rotation by a common main motor driveshaft;
the blades are mounted on blade driveshafts that are driven in rotation independently of one another;
at least two blades are driven in rotation at different speeds of rotation;
an additional blade is provided that is free in said container;
a blocking mechanism is provided for blocking said free additional blade in said container; and
a stationary deflector element is provided in said container.

### DETAILED DESCRIPTION OF AN EMBODIMENT

The following description made with reference to the accompanying drawings, which are given as non-limiting examples, make it clear what the invention consists in and how it can be performed.

In the accompanying drawings:

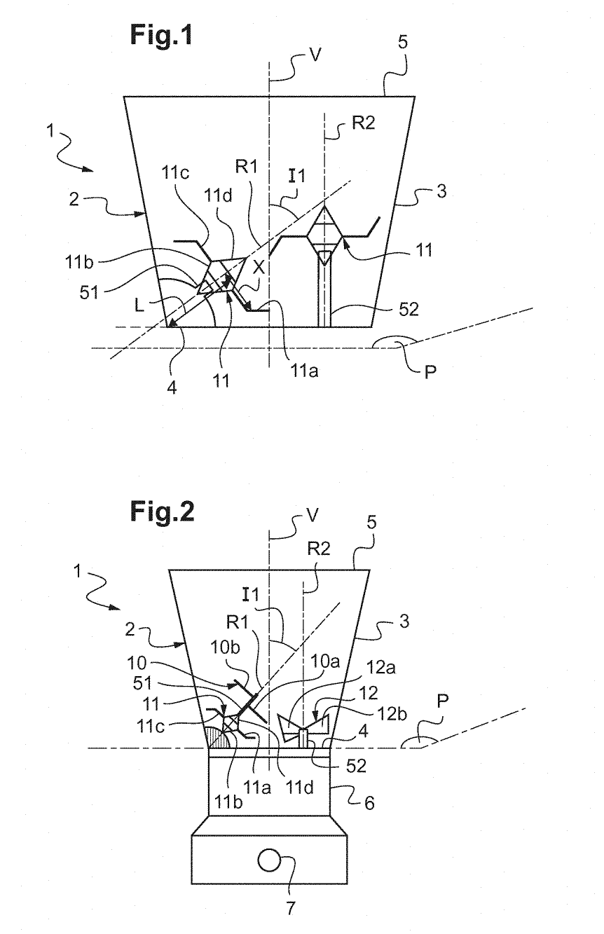

FIG. 1 is a diagrammatic view of a first embodiment of a food preparation device of the invention;

FIG. 2 is a diagrammatic view of a second embodiment of a food preparation device of the invention;

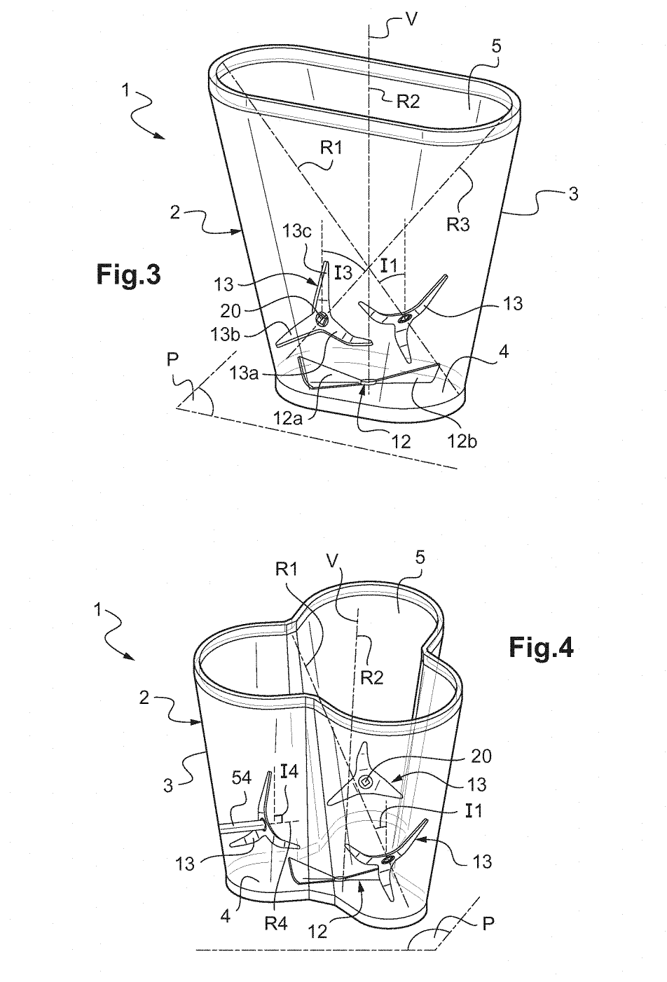

FIG. 3 is a fragmentary diagrammatic view in perspective of a third embodiment of a food preparation device of the invention;

FIG. 4 is a fragmentary diagrammatic view in perspective of a fourth embodiment of a food preparation device of the invention; and

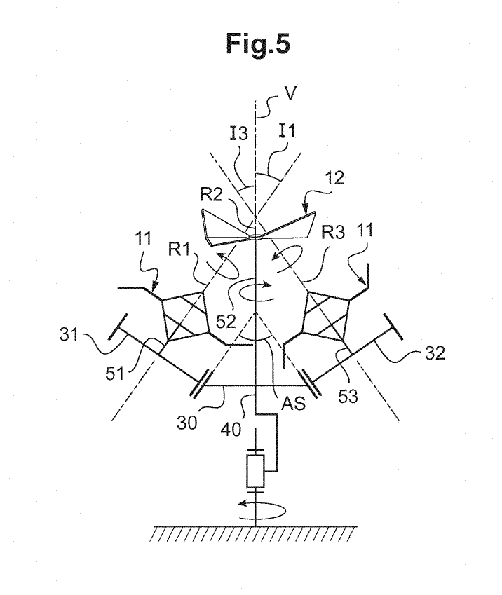

FIG. 5 is a diagram of a first possible rotary drive mode for the blades in the container.

As a preliminary point, it should be observed that, whenever possible, elements that are identical or similar in the various embodiments shown are referenced by the same reference signs and are not described each time.

In FIGS. 1 to 4, there are shown various embodiments of a food preparation device 1 for processing food, i.e. for mixing food, transforming it into powder, into a puree, or into a liquid, or indeed for chopping food or grinding it.

Whatever the embodiment concerned, the food preparation device 1 comprises a container 2 suitable for receiving the food that is to be prepared, and at least two blades 10, 11, 12, 13 arranged in the container 2 and adapted to process the food inserted in said container 2.

The term “blade” is used to mean a part made of hard material, of metal or of plastics material, for example, that is relatively flat and thin, of more or less elongate shape, and generally narrow. Thus, in the presently understood meaning, a blade may be a paddle for stirring without necessarily being a sharp object for cutting or slicing.

In the description below, it is considered that a cutting edge is sharp if it is sufficiently fine for slicing. Such sharpening may be performed by way of example on a grindstone or using any other mode known to the person skilled in the art.

In this example, the blades 10, 11, 12, and 13 are made of a material that is compatible with processing food that is to be consumed by human beings.

In conventional manner, the container 2 is also made of a material that is compatible with processing food suitable for being consumed by human beings. It is also washable and relatively rigid.

In this example, the material used for making the container 2 is a plastics polymer material that is advantageously transparent.

In a variant, the container 2 could be made of glass, or of opaque plastics material.

The container 2 presents a bottom 4 from which there rises a side wall 3 leading to an opening 5 of the food preparation device 1.

The opening 5 enables food to be inserted into the container 2, and enables food to be extracted from said container 2 once it has been processed.

In the drawings shown, the bottom 4 is flat. The plane defined by this bottom 4 is given reference P in FIGS. 1 to 4.

In a variant, it could have a concave shape generally facing towards the opening.

The side wall 3 rises from the bottom 4 generally along a vertical axis V. The vertical axis V is perpendicular to the bottom 4 when the bottom is flat. The vertical axis V passes through the center of a bottom 4 that is concave and it is then perpendicular to the plane that is tangential to the bottom 4 at that center.

More precisely, in the first, second, and third embodiments of the food preparation device 1 shown respectively in FIGS. 1 to 3, the bottom 4 is a flat surface of circular or elliptical shape and the side wall 3 rises while sloping a little relative to the vertical axis V associated with the bottom 4 so that the container 2 presents a flared shape, the area of the bottom 4 being smaller than the area of the opening 5 of the food preparation device 1.

Advantageously, the flared shape of the container 2 enhances the flow of food within the container 2 while the food preparation device 1 is in operation.

In addition, this flared shape makes it easier to insert food into the container 2, and also to extract it.

In a variant, as in the fourth embodiment shown in FIG. 4, the bottom 4 may present a surface that is more complex, and the side wall 3 is then itself complex since it follows the outline of that surface, while also rising with a small slope relative to the vertical axis V of the container 2.

In conventional manner, whatever the intended embodiment, the side wall 3 rises vertically over a few tens of centimeters.

The container 2 is arranged on a stand 6 (see FIG. 2) enclosing at least one motor adapted to set the blades 10, 11, 12, 13 into rotation about respective axes of rotation R1, R2, R3, R4.

In this example, the motor is of power lying in the range 200 watts (W) to 2000 W. It is controlled by a user via an interface 7 that is directly accessible on an outside face of the stand 6 (see FIG. 2).

Each blade 10, 11, 12, 13 is mounted on a blade driveshaft 51, 52, 53, 54 provided in the bottom 4 of the container 2 and adapted to rotate said blade 10, 11, 12, 13.

In conventional manner, each blade is thus provided in a generally central region with a hub 20 for mounting on the blade driveshaft 51, 52, 53, 54 (see in particular FIGS. 3 and 4) from which there extend a plurality of fins 10a, 10b; 11a, 11b, 11c, 11d; 12a, 12b; 13a, 13b, 13c of the blades 10, 11, 12, 13 (see FIGS. 1 and 3).

Thus, the blade 10, 11, 12, 13 is mounted inside the container 2 by engaging its central hub 20 on the corresponding blade driveshaft 51, 52, 53, 54.

Advantageously, each blade driveshaft 51, 52, 53, 54 may receive one or more blades 10, 11, 12, 13.

In the presently-described examples, the blades 10, 11, 12, 13 are secured to the blade driveshafts 51, 52, 53, 54 carrying them, i.e. they are integral with their respective blade driveshafts 51, 52, 53, 54.

In a variant that is not shown, it is possible to envisage the blades being removably mounted on the driveshaft, i.e. in such a manner as to enable them to be put into place on and removed from the driveshafts, depending on requirements.

In this advantageous variant, the blades are thus easier to wash.

In addition, still in this variant, each blade could be locked onto the corresponding blade driveshaft in such a manner as to be incapable of escaping from the blade driveshaft while the food preparation device is in operation, i.e. while the blades are being driven in rotation.

Each blade driveshaft 51, 52, 53, 54 presents a main axis that coincides with the axis of rotation R1, R2, R3, R4 of the blade 10, 11, 12, 13 that it supports.

The axis of rotation R2 of at least one of the blades 10, 11, 12, 13 arranged in the container 2 extends along the direction of the vertical axis V.

In remarkable manner, the axis of rotation R1, R3, R4 of at least one other one of the blades 10, 11, 12, 13 arranged in the container 2 is inclined at a non-zero angle of inclination I1, I3, I4 relative to said vertical axis V of the container 2.

In other words, the main axis of at least one blade driveshaft 52 for the blades 10, 11, 12, 13 is parallel with the vertical axis V of the container 2 without necessarily coinciding with the vertical axis V, and the main axis of at least one other one of the blade driveshafts 51, 53, 54 of the blades 10, 11, 12, 13 intersects the vertical axis V of the container 2 without coinciding with said vertical axis V.

Providing a configuration in which one axis of rotation is vertical and another axis of rotation is inclined makes it possible to increase the stirring of food in the container and to improve the flow of material inside said container.

The term “angle of inclination” is used herein to mean the smallest angle between said vertical axis V of the container 2 and the axis of rotation R1, R3, R4 of the corresponding blade 10, 11, 12, 13.

More precisely, in this example, each angle of inclination I1, I3, I4 is an acute angle or a right angle.

In advantageous manner, the value of the angle of inclination I1, I3, I4 associated with each inclined axis of rotation R1, R3, R4 of a blade 10, 11, 12, 13 lies in the range 5 degrees to 90 degrees.

The value of the angle of inclination I1, I3, I4 of at least one of the blades may in particular lie in the range 40° to 90°.

By way of example, providing a blade having its axis of rotation vertical and a blade having its axis of rotation inclined at 90° makes it possible to improve most particularly the stirring of food within the container.

Providing one blade with its axis of rotation vertical and another blade with its axis of rotation inclined at 45° also makes it possible to improve the stirring of food and the flow of material within the container, thereby reducing waste when using the food preparation device.

Advantageously, the inclination of at least one of the blades 10, 11, 12, 13 of the food preparation device 1 of the invention is such that it makes it possible to break the generally circular movement of the stream of food created around the vertical axis V of the container 2 (or an axis of rotation extending along the direction of the vertical axis V). This configuration makes it easier for food to flow in said container 2, the food thus being processed in more uniform manner.

In other words, associating a vertical blade with an inclined blade improves the circulation of food throughout said container 2, thereby enhancing uniform processing of the food and making it possible to reduce the duration of an operating cycle of the food preparation device 1.

Furthermore, the inclined axes of rotation preferably extend towards the center of the container (see FIGS. 1 to 5).

The blades 10, 11, 12, 13 thus face towards the main volume of the container 2 rather than towards the side wall 3 to which they are closest. This enhances stirring of all of the food contained in the container 2.

The shape of the blades 10, 11, 12, 13 is compatible with their respective angles of inclination and/or verticality, such that when the blades are driven in rotation about their axes of rotation R1, R2, R3, R4, said blades 10, 11, 12, 13 do not strike against the bottom 4 nor against the side wall 3 of the container 2.

In other words, the length of the fins 10a, 10b; 11a, 11b, 11c, 11d; 12a, 12b; 13a, 13b, 13c of each blade 10, 11, 12, 13 and the distance from the bottom 4 at which each blade 10, 11, 12, 13 is mounted on its blade driveshaft 51, 52, 53, 54 are compatible with the value of the angle of inclination I1, I3, I4 so that said blades 10, 11, 12, 13 can rotate inside the container 2 without coming into contact with the side wall 3, the bottom 4, or the other blades 10, 11, 12, 13.

In practice, and by way of example, the blades 10 that are used present fins 10a, 10b that are short enough not to strike against the side wall 3 of the container 2.

The blades 11, 13 present fins 11a, 11b, 11c, 11d; 13a, 13b, 13c having free ends that are curved (see FIGS. 1 and 3).

In particular, and with reference to a situation of the kind shown in FIG. 1, when the free end of the fin 11a of the blade 11 is curved and the value of the angle of inclination I1 of the axis of rotation R1 is such that said end is parallel to the flat bottom 4 of the container 2, it is possible to establish the maximum length X of the non-curved portion of the fin as a function of the values of said angle of inclination I1 and of said distance L at which the blade 11 is mounted along the blade driveshaft 51. This maximum length X can be estimated using the following mathematical relationship:

X=L/tan(I1)

Furthermore, the blades 10, 11, 12, 13 are arranged in the proximity of the bottom 4 of the container 2, i.e. between the bottom 4 of the container 2 and halfway up the total height of said container 2. It is considered that the “total height” of the container 2 is the overall dimension of the container 2 measured along the vertical axis V.

In preferred manner, the blades 10, 11, 12, 13 are arranged between the bottom 4 of the container 2 and one-third of the total height of the container 2, starting from the bottom 4 of the container 2.

Nevertheless, it is also possible to make provision for the blades to be situated at any height within the container.

Under all circumstances, for practical reasons, the blades are situated at a distance that is greater than or equal to 5 mm from the bottom 4 of the container 2.

Furthermore, arranging at least some of the blades provided in the container at mutually different heights serves to further increase the stirring of food and thus to achieve a more uniform result in terms of chopping, mixing, and/or stirring.

Because of the particular arrangement of the blades 10, 11, 12, 13 in the food preparation device 1, as results simultaneously from their inclinations, from their positions, and from their heights in the container 2, the food is likely to encounter each blade 10, 11, 12, 13 several times, thereby advantageously reducing the quantity of waste generated during the operation of said food preparation device 1.

Furthermore, it is possible to provide an additional blade in said container 2 that is free. This free additional blade is mounted on a shaft, but unlike the other blades, it is not driven in rotation on that shaft. On the contrary, it is an “idle” blade since it is free to turn about its axis of rotation under the effect of the stream of material created inside the container when the food preparation device is in use.

Like the other blades, the axis of rotation associated with this additional blade may either extend in the direction of the vertical axis, or else it may be inclined relative to said vertical axis.

It is possible to envisage two types of mounting for the additional blade in the container.

In the first type of mounting, the mounting shaft of the additional blade is stationary in the container, and the additional blade is mounted on that shaft so as to be capable of turning freely about it when it is driven in rotation by the stream of material flowing in the container.

In the second type of mounting, the additional blade is securely mounted on its mounting shaft, such that additional blade and said mounting shaft are stationary relative to each other, but the assembly formed by additional blade and said mounting shaft is free to rotate about the axis of rotation when the blade is driven by the stream of material flowing in the container.

Advantageously, adding such a free blade in addition to the minimum of two blades provided in the container 2 serves to further disturb the stream of material and to increase the stirring of food inside said container.

That free additional blade is preferably a stirring paddle 12, but it could be any other type of blade.

According to an advantageous characteristic, it is also possible to provide a blocking mechanism for blocking said free additional blade in said container. In other words, provision may be made to block free rotation of the additional blade so that it become stationary inside the container in spite of the stream of material created in said container.

The stationary additional blade disturbs the flow of material, thereby increasing the stirring of food.

The mechanism for blocking the additional blade may be activated or deactivated via the interface 7 of the food preparation device 1.

In particular, when the additional blade is mounted in the container using the second type of mounting, it is possible to envisage that the blocking mechanism can act on the mounting shaft of said additional blade. For example, it is possible to envisage that the shaft is terminated by a gearwheel arranged in the stand 6 of the food preparation device 1. The gearwheel, forming the blocking mechanism, can adopt one position in which it meshes with an element of the stand so as to prevent rotation of the mounting shaft, and another position, in which it is free so that the mounting shaft can be set into rotation by the stream of material acting on the additional blade.

According to another characteristic of the invention, it is possible to provide a deflector element inside the container of the food preparation device.

By way of example, such a deflector element is arranged in the bottom of the container, between the various rotary shafts of the blade.

It may also be arranged on the wall of the container, in a region of the container that is situated above the region in which the blade rotates.

It is a stationary element that is adapted to disturb the stream of food on the same principle as the additional blade when its free rotation is blocked.

By way of example, it may be an element made of stainless steel having the shape of a blade such as that described above, with or without a sharp cutting edge.

By means of such a deflector element, the stirring of food is increased, thereby making it possible to shorten the duration of a complete operating cycle of the food preparation device of the invention.

In the description below, various embodiments of the invention are described in greater detail.

In the first embodiment of the food preparation device 1 as shown in FIG. 1, the bottom 4 receives first and second blade driveshafts 51 and 52, each supporting a blender blade 11.

Such a blender blade 11 is known to the person skilled in the art. It may present certain sharp cutting edges. By way of example, it may be a blade sometimes referred to as a blender knife.

More precisely it has four fins 11a, 11b, 11c, 11d that are not plane, each having a sharp cutting edge. These fins 11a, 11b, 11c, 11d are symmetrical in pairs.

Its particular shape makes it suitable for reducing relatively soft food into puree and for reducing harder food into small pieces. For example, it is suitable for making crushed ice. In this example it is made of stainless steel.

As can be seen in FIG. 1, one of the blender blades 11 is driven in rotation about a first axis of rotation R1 that is inclined at an angle of inclination I1 having a value selected to be 50° in this example.

The other blender blade 11 is driven in rotation about a second axis of rotation R2 that extends in the direction of the vertical axis V and that is off-center relative to the bottom 4 of the container 2, such that said second axis of rotation R2 does not coincide with the vertical axis V.

In addition, in this first embodiment, the two blender blades 11 are situated at different heights relative to the bottom 4 of the container 2: the blender blade 11 for rotation about the first axis of rotation R1 is situated between the bottom 4 of the container 2 and one-third of the total height of said container 2, while the other blender blade 11 is situated between one-third and one-half of the total height of said container 2, starting from the bottom 4.

In the second embodiment of the food preparation device 1, as shown in FIG. 2, the bottom 4 of the container 2 receives first and second blade driveshafts 51 and 52, as in the first embodiment. Two distinct and different blades 10 and 11 are mounted on the first blade driveshaft 51, and another blade 12 is mounted on the second blade driveshaft 52.

The two blades 10, 11 mounted on the same first blade driveshaft 51 are rotated about a common first axis of rotation R1 that is inclined at an angle of inclination I1 of value equal to 45°, relative to the vertical axis V of the container 2.

In practice, these two blades 10 and 11 are spaced apart from each other by a distance lying in the range 5 mm to 50 mm, e.g. equal to 10 mm along said common axis of rotation.

The blade 12 is rotated about a second axis of rotation R2 extending in the direction of the vertical axis V, without coinciding with the vertical axis V in this example.

The blade 10 used in this example is more commonly referred to as a meat grinder blade 10. It is known to the person skilled in the art and is described only briefly. It has a sharp cutting edge so as to be particularly suitable for cutting up or chopping food. The material used for making such a grinder blade is thus compatible with potential sharpening of the blade. For example, it may be stainless steel.

The blade 11 is the above-described blender blade 11.

In this example, the blade 12 is more commonly referred to as a stirring paddle 12. Such a stirring paddle 12 is known to the person skilled in the art. Advantageously, because of its shape, it is adapted to cause food to move so that it is processed in uniform manner by the other blades of the container.

In this example, it has two non-plane fins 12a and 12b. Each fin 12a, 12b is curved longitudinally so that the free edges of each fin 12a, 12b do not lie in the same plane.

In this example, the blade 12 is made of rigid plastics material. In a variant, it is possible to make it out of stainless steel.

Provision may also be made to mount one or more additional blades on the first and/or the second blade driveshaft in a variant of this second embodiment.

In the third embodiment of the food preparation device 1 shown in FIG. 3, the bottom 4 receives three blade driveshafts (not shown) each supporting a single blade: either another type of blender blade 13, or a stirring paddle 12.

The blender blades 13 differ from the blender blades 11 in that they do not have four fins, but rather three fins 13a, 13b, 13c that are not plane.

The free end of each of the three fins 13a, 13b, 13c is curved, and each fin 13a, 13b, 13c presents a sharp cutting edge.

The blender blades 13 in this example are made of stainless steel. The blender blade 13 may sometimes be referred to as a blender knife.

The third embodiment differs from the first two embodiments in that it includes the third blade driveshaft 53 for driving a blade 13 in rotation about a third axis of rotation R3.

Thus, in the third embodiment, the blender blades 13 are set into rotation respectively about the first axis of rotation R1 and about the third axis of rotation R3, said first and third axes of rotation R1 and R3 being inclined respectively at a first angle of inclination I1 and at a third angle of inclination I3, each equal to 35°.

The stirring paddle 12 is set in rotation about the second axis of rotation R2 parallel to the vertical axis V of the container 2.

More precisely, in this third embodiment, the second axis of rotation R2 of the blade 12 extends in the direction of the vertical axis V and coincides therewith.

This stirring paddle 12 is situated in the direct proximity of the bottom 4 of the container 2, i.e. as close to the bottom 4 as possible, e.g. at 5 mm from the bottom 4 of the container 2. In addition, it is generally positioned at the center of the bottom 4 of the container 2, i.e. at a distance from the side wall 3.

Advantageously, this position for the stirring paddle 12 makes is suitable for setting food into movement that would otherwise tend to become deposited on the bottom 4 of the container 2.

In addition, and advantageously, the vertical second axis of rotation R2 of the stirring paddle 12 is adapted to cause food to rise from the bottom 4 towards the opening 5 of the container 2, so as to direct food towards the blender blades 13 contained in the container 2.

In a variant of this third embodiment, it is possible to envisage that one of the blender blades is free to rotate on its mounting shaft instead of being driven in rotation thereby. It is then the stream of food created by driving the other blades 12 and 13 in rotation that serves to cause the free blade to rotate.

Naturally, in a variant, it is possible to envisage that the free blade is positioned on a vertical shaft, such that the stream of food sets it into rotation about an axis of rotation that extends in the direction of the vertical axis.

The fourth embodiment shown in FIG. 4 is similar to the third embodiment except that the angle of inclination I1 of the axis of rotation R1 of one of the blender blades 13 is 40° instead of 35°, and an additional blender blade 13 is placed on a fourth blade driveshaft 54 suitable for driving said blender blade 13 in rotation about a fourth axis of rotation R4 that is inclined at an angle of inclination 14 equal to 90°.

In practice, the mechanism (not shown) for driving the additional blender blade 13 in rotation about the fourth axis of rotation R4 that is perpendicular to the vertical axis V runs along the outside of the wall 3 of the container 2.

In a variant, the additional blender blade 13 could be mounted free to rotate on its mounting shaft, so as to be able to rotate freely about the fourth axis of rotation R4 under the effect of the stream of material created in the food preparation device 1 while in operation.

Naturally, some of the embodiments described are mutually compatible, and provision could be made to combine them.

It is also possible to envisage interchanging the various blades described and/or using any other blade known to the person skilled in the art in the food preparation device of the invention.

Below, first and second modes of driving the blades 10, 11, 12, 13 in rotation are described in detail.

Whatever the drive mode described, the blades 10, 11, 12, 13 are secured to the blade driveshafts 51, 52, 53, 54 when the food preparation device 1 is in operation, and it is considered that the direction of rotation and the speed of rotation of each blade 10, 11, 12, 13 are imposed by the direction of rotation and the speed of rotation of the blade driveshafts 51, 52, 53, 54 on which the blade is mounted.

In the first mode of driving the blades in rotation, the blades are mounted on blade driveshafts 51, 52, 53, 54 that are driven in rotation by a common main motor driveshaft 40.

Advantageously, this first mode of driving the blades in rotation requires only one motor and it is easy to implement.

FIG. 5 shows the first possible mode of driving the blades in rotation in a device of the invention.

The food preparation device 1 in FIG. 5 is similar to that shown in FIG. 3: it has two blender blades 11 and one stirring paddle 12 that are driven in rotation on first, second, and third distinct blade driveshafts 51, 52, and 53.

The first and third blade driveshafts 51 and 53 are inclined relative to the vertical axis V such that the first and third angles of inclination I1 and I3 of the first and third axes of rotation R1 and R3 of the blender blades 11 present values that are identical, and the blender blades 11 are placed at the same height inside the container 2.

The second blade driveshaft 52 is vertical such that the second axis of rotation R2 of the stirring paddle 12 extends in the direction of the vertical axis.

In FIG. 5, the first, second, and third blade driveshafts 51, 52, 53 of the blades 11, 12 are connected to the motor driveshaft 40.

To this end, the motor driveshaft 40 is terminated by a bevel gear 30. This bevel gear 30 is extended on the other side by the second blade driveshaft 52. The bevel gear 30 engages firstly with a first spur gear 31 terminating the blade driveshaft 51, and secondly with a second spur gear 32 terminating the third blade driveshaft 53.

The term “spur gear” is used herein to designate a gear presenting an envelope that is cylindrical, ignoring the shape of its teeth. Similarly, a “bevel gear” is a gear presenting an envelope that is in the form of a truncated cone, ignoring the shape of its teeth.

As shown in FIG. 5, the gears in this example are solid gears each presenting a single outer envelope receiving the teeth of said gears.

In a variant, it is possible to envisage using ring gears presenting both an inner envelope and an outer envelope, with teeth being situated on the inner envelope and/or on the outer envelope.

Such gears, whether ring gears or solid gears, are known to the person skilled in the art, and in particular their repercussions on respective directions of rotation are known and are not described in greater detail.

In the example shown in FIG. 5, the teeth of the first and second spur gears 31 and 32 engage directly with the teeth of the bevel gear 30 of the motor driveshaft 40. The first and second driveshafts 51 and 53 then rotate in the same direction, opposite to the direction of rotation of the motor driveshaft 40 and of the bevel gear 30.

Thus, the direction of rotation of the blender blades 11 is opposite to the direction of rotation of the stirring paddles 12 carried by the vertical second blade driveshaft 52.

Furthermore, in the example of FIG. 5, the first and second spur gears 31 and 32 have the same radius, such that both blender blades 11 are driven at the same speed of rotation.

Furthermore, in this example, the first and third angles of inclination I1 and I3 of the first and third axes of rotation R1 and R3 of the blender blades 11 are equal, each being half the angle at the apex AS of the bevel gear 30.

It is considered that the angle at the apex AS is the angle formed by extending two director lines of the envelope of the bevel gear 30 that face each other on opposite sides of the motor driveshaft 40 associated with the bevel gear 30.

Mathematically, it is possible to write the following:

AS=I1+I3

and

I1=I3=AS/2

In a variant, provision could be made to select different radii and different numbers of teeth for the first and second gears, so as to modify the speed of rotation associated with each of the first and third blade driveshafts.

Furthermore, and in general manner, the angle of inclination of the axes of rotation of the blades stem directly from assembling the various bevel or spur gears together. Thus, provision could be made for the gear terminating the motor driveshaft to be a spur gear, and for the gears terminating the first and third blade driveshafts to be bevel gears having different angles at the apex, such that the angles of inclination of the first and third axes of rotation of the blades are different. Such assemblies are known to the person skilled in the art and are not described in greater detail.

In another variant, provision could be made for an intermediate gear to be placed between the gear terminating the motor driveshaft and the gear terminating one of the blade driveshafts. Thus, the direction of rotation of such a blade driveshaft becomes the same as that of the motor driveshaft. Advantageously, the speed of the blade driveshaft then depends on parameters of the intermediate gear, and in particular on the radius of the intermediate gear.

Provision may also be made to have a plurality of intermediate gears between the gear terminating the blade driveshaft and the gear terminating the motor driveshaft, which would have an influence on the direction of rotation and the speed of rotation of the blade driveshaft in question.

It can thus be understood that in the first mode of driving the blades in rotation, it is possible to drive all of the blade driveshafts in rotation in the same direction of rotation, or in opposite directions of rotation, and at the same speed of rotation, or at different speeds of rotation.

When the speeds of rotation of the blade driveshafts are different from one another, these speeds of rotation remain directly proportional to the speed of rotation of the motor driveshaft, such that the ratios between the speeds of rotation of the first, second, and third blade driveshafts are always constant.

In other words, by modifying the speed of rotation of the motor driveshaft, the user can modify the speeds of rotation of the blade driveshaft without modifying the ratios between the speeds of rotation of those blade driveshafts.

In the second mode of driving the blades in rotation, provision is made for the blade driveshaft to be driven in rotation independently of one another.

Advantageously, this second mode of driving the blades in rotation offers great flexibility in use, insofar as each blade can be controlled individually.

In this second mode of driving the blades in rotation, each blade driveshaft is associated with a distinct motor. In other words, under such circumstances, the stand of the food preparation device contains at least two different motors, and specifically as many motors as there are blade driveshafts.

Thus, the speeds of rotation and the directions of rotation of the blade driveshafts are independent of one another. Consequently, there need not be any proportionality ratio between the speeds of the various blades.

Advantageously, regardless of the modes of driving the blades in rotation, if the blades 10, 11, 12, and 13 present directions of rotation that are opposite, the stream of food within the container 2 becomes complex, thereby enhancing the flow of said food within the container 2 and ensuring that the food is processed more uniformly.

The present invention makes it possible to improve the stirring of food in the container. It thus makes it possible to reduce considerably the quantity of waste generated during a cycle of operating the device. It also makes it possible to improve the uniformity of the resulting food preparations, and to do so in a single operating cycle, which furthermore is shorter than the operating cycles that are usual for food preparation devices presently on the market.

The invention is not limited in any way to the above-described embodiments and modes of driving the blades in rotation, and the person skilled in the art knows how to combine those various embodiments and modes and to how make any desired variation thereof.

1. A food preparation device comprising:
a container suitable for receiving food for preparation, the container presenting a bottom and a side wall that rises from the bottom generally along a vertical axis; and
at least two blades arranged in the container, each blade being driven in rotation about an axis of rotation, the axis of rotation of at least one of the blades extending in the direction of said vertical axis;
the device being characterized in that the axis of rotation of at least one of the other blades is inclined at a non-zero angle of inclination relative to said vertical axis.

2. A device according to claim 1, wherein the value of each angle of inclination lies in the range 5 degrees to 90 degrees.

3. A device according to claim 1, wherein the value of at least one angle of inclination lies in the range 40 degrees to 90 degrees.

4. A device according to claim 1, wherein at least one axis of rotation is provided that is common to at least two blades.

5. A device according to claim 4, wherein two blades carried by the common axis of rotation are separated from each other by a distance lying in the range 5 mm to 50 mm along said common axis of rotation.

6. A device according to claim 1, wherein at least one of the blades is positioned in the proximity of the bottom of the container.

7. A device according to claim 1, wherein at least two blades present opposite directions of rotation.

8. A device according to claim 1, wherein at least one of the blades presents a sharp cutting edge.

9. A device according to claim 1, wherein at least one of the blades is a stirring paddle.

10. A device according to claim 1, wherein the blades are mounted on blade driveshafts that are driven in rotation by a common main motor driveshaft.

11. A device according to claim 1, wherein the blades are mounted on blade driveshafts that are driven in rotation independently of one another.

12. A device according to claim 1, wherein at least two blades are driven in rotation at different speeds of rotation.

13. A device according to claim 1, wherein an additional blade is provided that is free in said container.

14. A device according to claim 13, wherein a blocking mechanism is provided for blocking said free additional blade in said container.

15. A device according to claim 1, wherein a stationary deflector element is provided in said container.

16. A device according to claim 2, wherein the value of at least one angle of inclination lies in the range 40 degrees to 90 degrees.

17. A device according to claim 2, wherein at least one axis of rotation is provided that is common to at least two blades.

18. A device according to claim 3, wherein at least one axis of rotation is provided that is common to at least two blades.

19. A device according to claim 2, wherein at least one of the blades is positioned in the proximity of the bottom of the container.

20. A device according to claim 3, wherein at least one of the blades is positioned in the proximity of the bottom of the container.
